(19) United States
(12) Patent Application Publication
(10) Pub. No.: US 2004/0035029 A1
(43) Pub. Date: Feb. 26, 2004

(54) Telephone line marking with destination indicia

(76) Inventor: Kevin Forsberg, Orlando, FL (US)

Correspondence Address: Bambi Faivre Walters, P.O. BOX 5743, Williamsburg, VA, 23188, US

(21) Appl. No.: 10/153,849

(22) Filed: May 22, 2002

(51) Int. Cl. G09F 3/00

(52) U.S. Cl. 40/316

(57) ABSTRACT

This invention provides a method of marking a destination indicia on a telecommunications component and the telecommunications component produced thereby. In an embodiment, the destination indicia is marked on a destination wire tag that is positioned on a portion of the telecommunications component. The method includes establishing a preconceived pattern of the destination indicia, marking the destination indicia on the destination wire tag, providing the telecommunications component, and attaching the destination wire tag on the portion of the telecommunications component. In another embodiment, the destination indicia is marked on a predetermined portion of a surface of the telecommunications component. This invention further includes a method for associating customer data (e.g., a customer's address, account number, line, called telephone number, etc.) and trackability data (e.g., network assembly data, manufacturing data, repair data, etc.) of the telecommunications component with the destination indicia. The destination indicia may include at least one alphanumerical character, a symbol, or combination thereof.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention relates generally to the field of telecommunications. More particularly, this invention includes a method of marking a destination indicia on a portion of a surface of a telecommunications component, such as a telephone line, and includes the apparatus produced thereby.

2. Description of the Related Art

Inherent with any telecommunications network is the need to connect routing wires to destination wires that provide telecommunications service to an individual and/or business. As used herein, the term routing wires include wires that are routed from a central office or other location (e.g., a crossbox) to a wire center or a turf that is within a local geographical area of a called telephone number. Typically, the routing wires may be bundled together in a cable surrounded by a protective sheath so that the resulting cable may be easily and securely routed over long distances. As used herein, the term destination wires includes wires that are connected with a customer's premises, such as drop wires from an aerial terminal. These destination wires may be connected directly with a communications device, such as a telephone, or more typically, the destination wires may be coupled with other wires integral with the customer's premise to eventually connect with the customer's communications device.

A common technique for connecting routing wires and destination wires is by terminating the routing wire and splicing it with the destination wire in a terminal or other appropriate telecommunications closure. As used herein, the term terminal includes terminals, closures, and other devices used to house routing wires and/or destination wires. Terminals may be polygon or non-polygon shaped and constructed of any appropriate material, such as, for example, metal, polymer, plastic, ceramic, glass, crystal, and the like. Typically, the terminal is located on or near an aerial pole (if the wires are aerially suspended), or an above-ground pedestal or buried box (if the wires are buried) within a selected geographic proximity to an address associated with the called telephone number. Typically, the routing wires are separated at the end of the cable, and an end of a routing wire is mated in the terminal on a terminal block with an end of the destination wire. Each destination wire is mounted in a passageway (e.g., a bore, channel, groove, or any other similar structure) formed through the terminal. The destination wire is routed out of the passageway and then to the location (e.g., customer's home or business located at an address) associated with the called telephone number (e.g., the customer's telephone number).

Often, there are numerous destination wires extending from the terminal in multiple directions. Given the various pathways and locations the destination wires travel, technicians working on the destination wires require destination routing information and other information (e.g., other telecommunications components involved in routing the destination wire to the customer's premise). For example, a technician must know which destination wire goes to which address, to which called telephone number at the address, and to which telephone line (if there is more than one destination wire routed to the same address). Typically, in order for a technician to determine whether a destination wire is routed to a particular address, the technician sets up a tracking tone or other measurable alert on the destination wire at the serviced address. Thereafter, the technician tests each destination wire at the terminal until he/she detects the tracking tone or other measurable alert over the destination wire. Because there are often a plurality of destination wires at the terminal, the testing process can involve testing each of these connections and be time-consuming.

In addition to the technicians needs described above, many telecommunication service providers require a way to track their network assemblies, such as, for example, using a manufacturing date or code on a terminal block to track the age or the type of manufacturing equipment. Conventional practice does not provide a consolidated marking method or apparatus that provides a destination indicia associated with the destination wire and associated with other telecommunications components in the network assembly.

### SUMMARY OF THE INVENTION

This invention addresses the above-described and other needs by providing a method of marking a destination indicia on a surface of a destination wire tag to attach or affix to a telecommunications component that connects or routes a destination wire, and includes the apparatus produced thereby. Alternatively, the marking method involves directly marking a portion of a surface of the telecommunications component with the destination indicia. The destination indicia is associated with information content related to the telecommunications component including customer information (e.g., a customer's address, account number, telephone line, telephone number, telecommunications service provider, etc.) and trackability information (e.g., name of manufacturer, model number, repair history, etc.). The destination indicia may be alphanumeric characters, symbols, and/or combinations thereof. When marking the destination indicia, differentiating planar colors of the destination indicia on the marked portion of the surface and of an unmarked portion of the surface may be used to better distinguish the destination indicia (e.g., marking black alphanumeric characters and/or symbols on a white surface). Further, the destination indicia may be marked, printed, etched, affixed, attached, stamped, or adhered to the surface. Alternatively, other methods of putting the destination indicia on the surface may be used, such as, for example, applying a film, substrate, magnetic material, or the like to the surface.

In an embodiment, this invention includes the destination wire tag produced by marking an attachment to the telecommunications component. The destination wire tag includes: (1) a tag body comprising engagement means to frictionally grip or to affix the destination wire, the tag body further comprising at least one surface; and (2) the destination indicia comprising a preconceived pattern associated with information content of the destination wire, the destination indicia located on a portion of the at least one surface. The destination wire tag may be manufactured from a variety of materials, such as, for example, paper, cloth, metal, polymer, plastic, ceramic, glass, crystal, and other appropriate materials. Further, the destination wire tag may be designed using a variety of shapes including polygons and non-polygons. In a further embodiment, the destination wire tag may include a separable, transparent sub-surface area located on the surface, the sub-surface area engaging the destination indicia to locate the destination indicia on the surface.

In another embodiment, the method of marking the telecommunications component includes: (1) establishing a destination indicia, wherein the destination indicia is associated with a destination wire, the destination wire having a first portion at least partially enclosed in a telecommunications closure and a second portion at least partially outside of the telecommunications closure, the second portion traveling to a predetermined destination; (2) providing a surface for marking; and (3) marking a portion of the surface with the destination indicia. If the surface to be marked is an attachment (e.g., a destination wire tag or a label to affix to the destination wire tag), then the method further includes, attaching the marking attachment to a predetermined portion of the telecommunications component.

Another embodiment includes a method of interpreting or associating customer information and/or trackability information with the destination indicia. This method includes: (1) aligning the destination indicia located on a portion of the surface of a telecommunications component (or on a destination wire tag) with a probe of an apparatus for reading the destination indicia, wherein the destination indicia is associated with at least one of customer data and trackability data; (2) reading the destination indicia with the probe; and (3) processing the destination indicia to interpret the at least one of customer data and trackability data.

### BRIEF DESCRIPTION OF THE DRAWINGS

The above and other embodiments, objects, uses, advantages, and novel features of this invention are more clearly understood by reference to the following description taken in connection with the accompanying figures, in which:

FIG. 1A is a perspective view of a box-shaped destination wire tag illustrating a destination indicia according to an embodiment of this invention;

FIG. 1B is a perspective view of the apparatus of FIG. 1A illustrating an opened position of the tag and position of the closure tabs;

FIG. 1C is a perspective view of the apparatus of FIG. 1A illustrating an opened position of the tag and position of the ledge that the closure tabs engage;

FIG. 2 is a perspective view of two box-shaped destination wire tags illustrating two destination indicia associated with the same address having multiple telephone lines according to an embodiment of this invention;

FIG. 3A is a perspective view of an alternate design of a destination wire tag illustrating a destination indicia according to an embodiment of this invention;

FIG. 3B is a perspective view of the apparatus of FIG. 3A illustrating an opened position of the tag;

FIG. 3C is a perspective view of the apparatus to FIG. 3A illustrating a further embodiment with a transparent window to engage a label with the destination indicia;

FIG. 4A is a perspective view of an alternate design of a triangular-shaped destination wire tag illustrating a destination indicia according to an embodiment of this invention;

FIG. 4B is a perspective view of the apparatus of FIG. 4A illustrating an opened position of the tag;

FIG. 5 is a perspective view of an adjustable destination wire tag illustrating a destination indicia according to an embodiment of this invention;

FIG. 6 is a perspective view of an alternate design of an adjustable destination wire tag illustrating a destination indicia according to an embodiment of this invention;

FIG. 7 is a perspective view of another alternate design of an adjustable destination wire tag illustrating a destination indicia according to an embodiment of this invention;

FIG. 8A is a perspective view of an alternate design of a circular-shaped destination wire tag illustrating a destination indicia according to an embodiment of this invention; and

FIG. 8B is a perspective view of the apparatus of FIG. 8A illustrating an opened position of the tag.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Like numbers refer to like elements throughout. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those of ordinary skill in the art that the schematics and the like represent conceptual views of illustrative structures embodying this invention.

In the claims hereof any element expressed as a means for performing a specified function is intended to encompass any way of performing that function including, for example, a combination of elements that performs that function. The invention as defined by such claims resides in the fact that the functionalities provided by the various recited means are combined and brought together in the manner that the claims call for. Applicant thus regards any means that can provide those functionalities as equivalent as those shown herein.

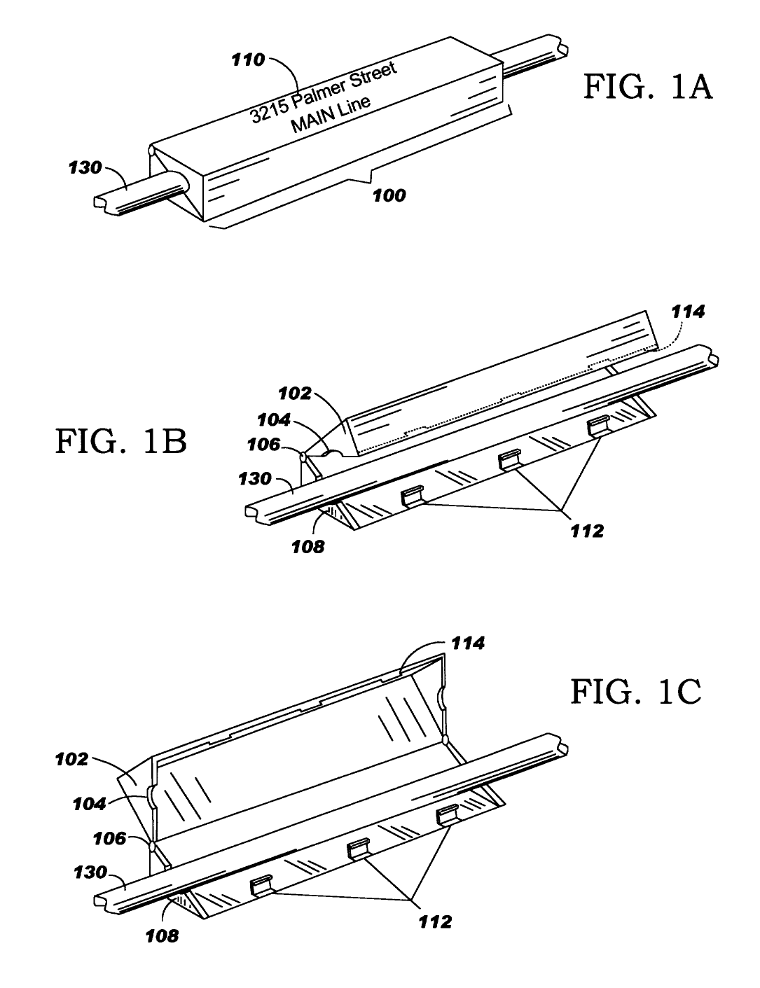

Referring to FIGS. 1A, 1B, and 1C, a destination wire tag 100 according to an embodiment of this invention is depicted. The destination wire tag 100 includes a tag body that comprises a first portion 102, a second portion 108, a center portion 106 for moving the first portion 102 and/or the second portion 108 relative to the other, a destination indicia 110, tabs 112, and ledges 114. The first portion 102 further includes a groove 104, and the second portion 108 may further include an opposed groove (not labeled). The groove 104 (and/or the opposed groove) may be used to position a destination wire 130 in the destination wire tag 100. When the first portion 102 and second portion 108 are mated (as shown in FIG. 1A), the tabs 112 engage the ledges 114 to frictionally grip the destination wire 130. This frictional grip securely attaches the destination wire tag 100 to the destination wire 130. The center portion 106 may be a hinge, a flexible joint, or a variety of other designs that are appropriate to provide relative movement of the first portion 102 and/or the second portion 108. As depicted, the wire destination tag 100 has a rectangular or square-shape when its portions 102 and 108 are engaged around the destination wire 130.

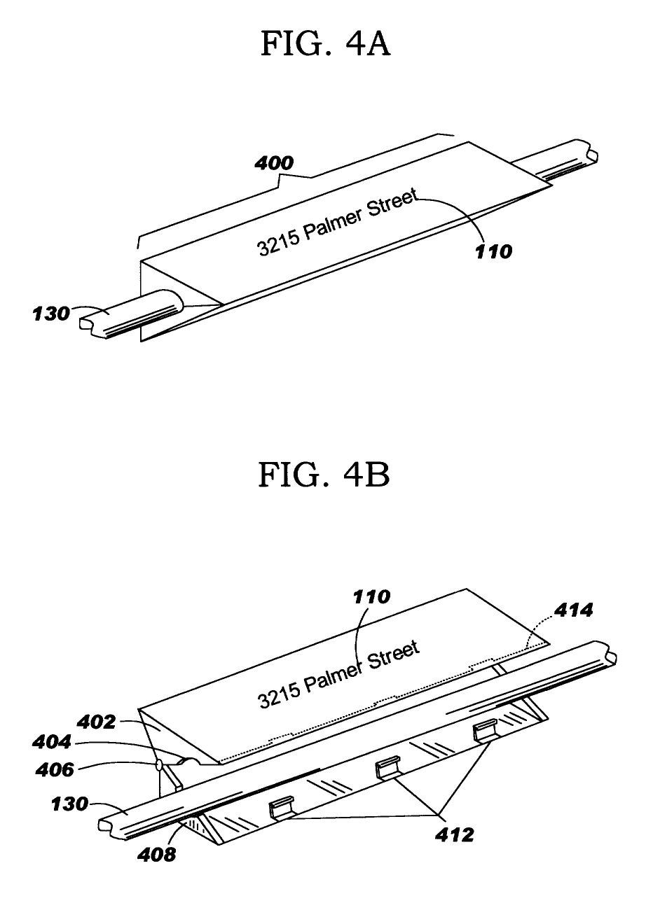

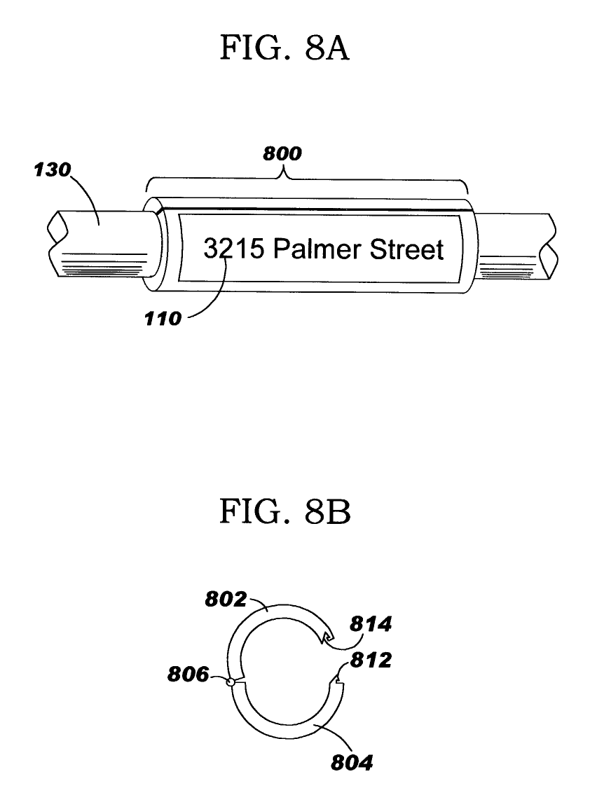

In alternate embodiments, the destination wire tag may take on additional shapes, such as, for example, the triangular shape of destination wire tag 400 in FIG. 4A or the circular shape of destination wire tag 800 in FIG. 8A. Further, the destination wire tag may be manufactured using any appropriate material that can provide a tag body to engage the telecommunications component (e.g., destination wire) and that can withstand environmental conditions, such as, a wide range of temperatures, humidity, and ozone exposure. For example, the destination wire tag could be constructed of paper, cloth, metal, polymer, plastic, ceramic, glass, crystal, and/or combinations thereof.

The destination indicia 110 is associated with customer information or data, such as, for example, a customer's address, account, telephone number, telephone line, telecommunications provider, and the like. In FIG. 1A, the depicted destination indicia 110 contains a variety of alphanumeric characters that represent a customer's address (i.e., “3215 Palmer Street”) and a telephone line (i.e., “MAIN Line”). In alternate embodiments, the destination indicia may be represented as a symbol, such as, for example, a Uniform Product Code (UPC) symbol depicted as destination indicia 510 in FIG. 5. Further, the destination indicia may be represented as a combination of alphanumeric characters, symbols, and combination thereof.

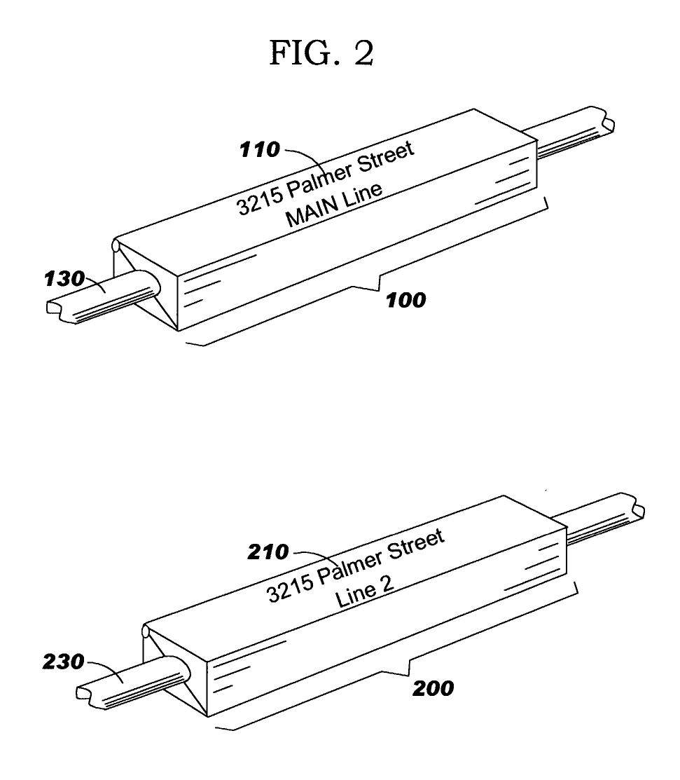

FIG. 2 illustrates two destination wire tags 100, 200 that provide telecommunication service to the same address, but different telephone lines. Destination wire tag 100 depicts destination indicia 110 serving “3215 Palmer Street, MAIN Line,” and destination wire tag 200 depicts destination indicia 210 serving “3215 Palmer Street, Line 2”. Thus, a technician who is tracking telephone lines from a terminal to a customer's address (or vice versa) would be able to identify (1) which telephone lines serve that customer's address and (2) which telephone lines serve each destination wire.

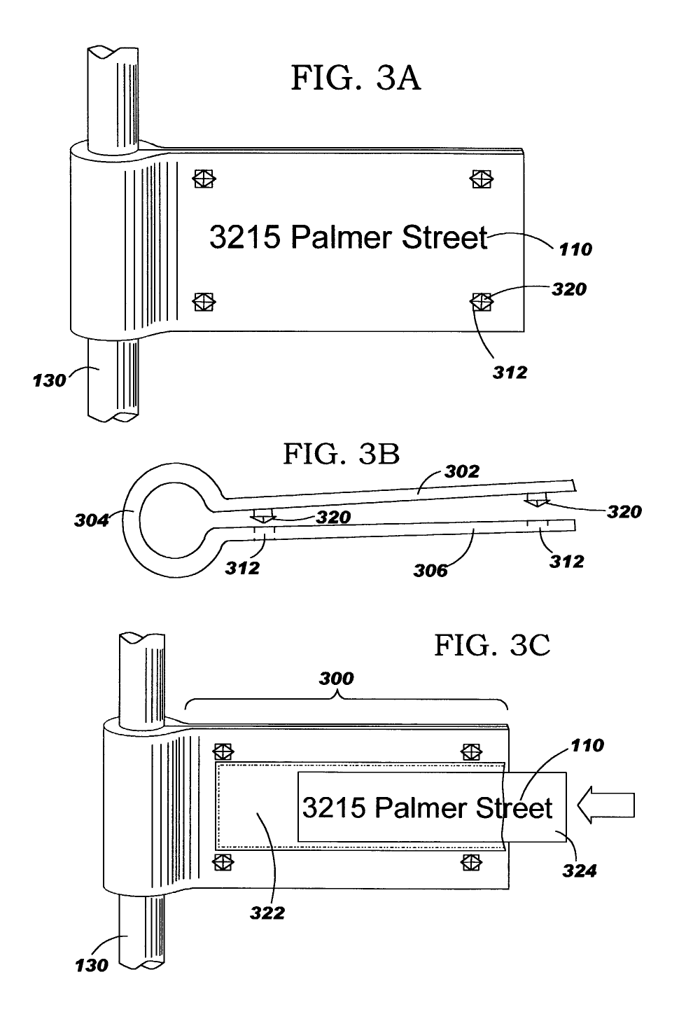

While the embodiments described above (FIGS. 1A-1C and FIG. 2) are related to a square-shaped, hinged tag body with tabs and ledges, this invention applies to a variety of destination wire tag designs that include: (1) a tag body having engagement means to frictionally grip or to affix to a destination wire, the tag body further having at least one surface, and (2) a destination indicia having a preconceived pattern associated with information content (e.g., customer information and/or trackability information) of the destination wire, the destination indicia being located on a portion of the surface. Some alternate designs are shown in FIGS. 3A-3C, 4A-4B, 5-7, and 8A-8B and further described in the passages below.

FIGS. 3A-3C illustrate a destination wire tag 300 having a first wing 302 with at least one small hole 312, an opposed second wing 306 with at least one small snap-in ridge 320, a center wire portion 304, and a destination indicia 110. The first wing 302 and the second wing 306 mate so that the snap-in ridges 320 securely fit into the holes 312 in a male-female relationship. Then the first wing 302 engages the second wing 306, the diameter of center wire portion 304 is reduced. The center wire portion 304 thus frictionally engages the destination wire 130. As shown in FIG. 3C, the destination wire tag 300 includes a separable sub-surface 322 of transparent material. A destination wire tag label 324 having the destination indicia 110 shown on the label 324 slides into an open end of the sub-surface 322. In further embodiments, the center wire portion 304 may also include clamping ridges (not shown) to fit a variety of destination wire sizes. The destination wire 130 could be fit into the clamping ridges so as to engage the destination wire 130 along its sides.

FIGS. 4A-4B depict a triangular-shaped destination wire tag 400 having a tag body that comprises a first portion 402, a second portion 408, a center portion 406 for moving the first portion 402 and/or the second portion 408 relative to the other, a destination indicia 110, tabs 412, and ledges 414. The first portion 402 further includes a groove 404, and the second portion 408 may further include an opposed groove (not labeled). The groove 404 (and/or the opposed groove) may be used to position a destination wire 130 in the destination wire tag. When the first portion 402 and second portion 408 are mated (as shown in FIG. 4A), the tabs 412 engage the ledges 414 to frictionally grip the destination wire 130 that securely attaches the destination wire tag 400 to the destination wire 130.

FIG. 5 shows a destination wire tag 500 having a first surface 502 with at least one small hole 512, a second surface 506 having at least one male protrusion 520, and a destination indicia 510. The first surface 502 and the second surface 506 mate so that the at least one male protrusion 520 engages the at least one small hole 512 in a snap-fit relationship. The first surface 502 and the second surface 506 frictionally engage the destination wire 130.

FIG. 6 illustrates another alternate destination wire tag design wherein the destination wire tag 600 includes a surface 610 with the destination indicia 110, a tail section 602 having at least one engagement tooth 604, and a passageway 606. The tail section 602 loops around the destination wire (shown as reference numeral 130 in FIG. 5) and inserts into the passageway 606. The at least one engagement tooth 604 is sized to frictionally engage the passageway 606. The tail section 602 is pulled through the passageway 606 until the resulting loop (not shown) is tight enough to frictionally engage the destination wire. The at least one engagement tooth 604 functions to securely retain the looped, pulled-through tail section 602 in frictional engagement with the destination wire.

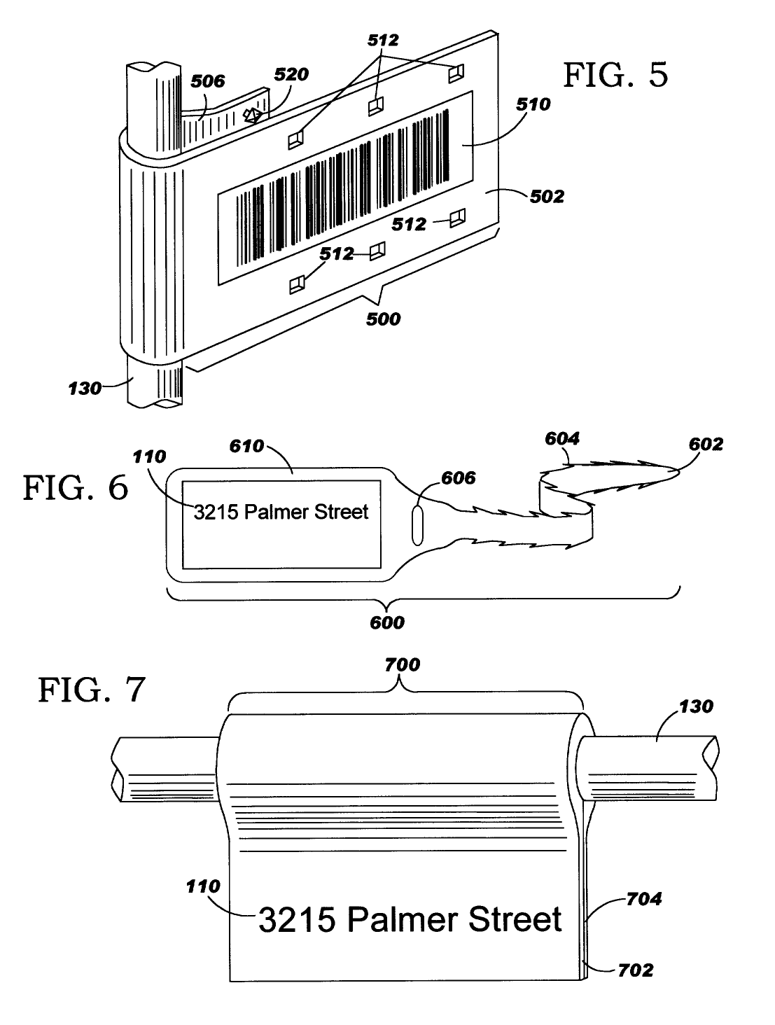

FIG. 7 depicts another embodiment having a destination wire tag 700 with a first face stock portion 702 with the destination indicia 110 and a second face stock portion 704. The back of the first face stock portion 702 and the back of the second face stock portion 704 are adhesively bonded together. The adhesive is capable of withstanding environmental conditions, such as, for example, a variety of temperatures, humidity, and ozone exposures.

FIGS. 8A and 8B depict a circular or sleeve-like shaped destination wire tag 800 having a tag body that comprises a first portion 802, a second portion 804, a center portion 806 for moving the first portion 802 and/or the second portion 804 relative to the other, a destination indicia 110, tabs 812, and ledges 814. When the first portion 802 and second portion 804 are mated (as shown in FIG. 8A), the tabs 812 engage the ledges 814 to frictionally grip the destination wire 130. This frictional grip securely attaches the destination wire tag 800 to the destination wire 130.

When marking the destination indicia, differentiating planar colors of the destination indicia on the marked portion of the surface and of an unmarked portion of the surface may be used to better distinguish the destination indicia (e.g., marking black alphanumeric characters and/or symbols on a white surface). The destination wire indicia may be placed on the destination wire tag (or telecommunications component, such as the destination wire) by a variety of methods, such as, for example, handwriting, affixing a computer-generated or handwritten label, thermal printing, etching, painting, or molding a destination wire tag with a portion of a raised surface area, and the like. For example, the destination indicia may be stamped or pressed into a metal or plastic destination wire tag. Alternatively, the marking may be accomplished by applying a film, a substrate, magnetic material, or the like to a portion of the telecommunications component or to a portion of the destination wire tag.

In another embodiment, the destination indicia may also be associated with trackability information or data related to the telecommunications component. For example, information that might be required by a technician or telecommunications provider might include manufacturing data (e.g., a manufacturer's name, model number, date, etc.), design specifications (e.g., height, width, etc.), repair history, maintenance history, installation information, replacement parts data, and other information associated with each of the other telecommunications components networked with the destination wire. For example, the technician could use the destination indicia to look up a history of work orders associated with the telecommunications component. The work orders would identify the type of work (e.g., repair, installation, testing, etc.), the technician that performed that work, the date of the work order, and other work related information. Further, the trackability information could provide a tool for technicians or telecommunication providers to accurately and efficiently automate auditing costs. Further, this information could provide a tool to quickly and accurately identify network assemblies, reduce network construction, maintenance, and repair costs, and monitor quality initiatives.

In further embodiments, this invention includes several methods of marking the telecommunications component. In an embodiment, a marking method involves: (1) establishing a destination indicia; (2) providing a surface for marking; and (3) marking a portion of the surface with the destination indicia. The destination indicia is associated with a destination wire which has a first portion that is enclosed in a telecommunications closure (e.g., an aerial closure) and a second portion that is outside of the telecommunications closure. Typically, the second portion of the destination wire travels to a predetermined destination, such as, for example, a customer's home or business at a particular address. If the surface to be marked is an attachment (e.g., a destination wire tag or a label to affix to the destination wire tag), then the method further includes, attaching the marking attachment to a predetermined portion of the telecommunications component (e.g., placing a destination wire tag label inside a separable sub-surface area).

In another embodiment, a method of marking a telecommunications component includes: (1) establishing a destination indicia; (2) providing the telecommunications component for marking; (3) preparing a portion of a surface for marking (e.g., cleaning the surface, placing the surface in a marking device, etc.); and (4) marking the portion of the surface with the destination indicia. The destination indicia is associated with a destination wire which has a mated portion (e.g., connection between wires that are routed from a central office or other location to a wire center or a turf that is within a local geographical area of a called telephone number and wires that are connected with a customer's premises, such as drop wires from an aerial terminal) and a routing portion outside of the telecommunications closure (e.g., a portion of the destination wire that travels from the aerial terminal to the customer's premises). Typically, the routing portion travels to a predetermined destination, such as the customer's home or business address. If the surface to be marked is a marking attachment (e.g., a destination wire tag), then the method further includes attaching the marking attachment to the telecommunications component.

In addition to the marking methods and apparatus described above, this invention includes a method of interpreting the destination indicia that involves: (1) aligning a destination indicia located on a telecommunications component with a probe of an apparatus for reading the destination indicia; (2) reading the destination indicia with the probe; and (3) processing the destination indicia to interpret customer data and/or trackability data. For example, if the destination indicia was a UPC symbol located on a destination wire tag attached to a destination wire, the UPC symbol could be read with a device that reads bar codes. The device could also associate the bar code with stored data related to a customer and/or related to network trackability information. As a further example, the retrieved data (e.g., a customer's address or manufacturing information regarding the telecommunications closure that houses the destination wire) could be viewed on a user display device linked with the device so that a technician could identify and act on the information.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A destination wire tag, comprising:
a tag body comprising means for frictionally engaging a destination wire of a telecommunications network, the tag body further comprising at least one surface; and
a destination indicia comprising a preconceived pattern associated with information content of the destination wire, the destination indicia located on a portion of the at least one surface.

2. The destination wire tag of claim 1, wherein the destination wire tag is made from at least one of the following materials:
paper;
cloth;
metal;
polymer;
plastic;
ceramic;
glass; and
crystal.

3. The destination wire tag of claim 1, the destination indicia having at least one alphanumeric character.

4. The destination wire tag of claim 1, the destination indicia having at least one symbol.

5. The destination wire tag of claim 1, the tag body further comprising:
an elongated sleeve comprising a first portion and a second portion, the first portion and the second portion including means for engaging the first portion with the second portion, such that the first portion and the second portion enclose a portion of the destination wire when engaged with each other.

6. The destination wire tag of claim 5, the destination wire tag further comprising:
a separable, transparent sub-surface area on the first portion, the subsurface area engaging the destination indicia to locate the destination indicia on the surface.

7. A destination wire tag, comprising:
a tag body having a surface for locating a destination indicia;
engagement means for affixing the tag body to a destination wire of a telecommunications network; and
the destination indicia comprising a preconceived pattern associated with information content of the destination wire, the destination indicia located on a portion of the surface.

8. A destination wire tag, comprising:
a tag body having a surface for locating a destination indicia;
engagement means to frictionally grip a destination wire of a telecommunications network; and
the destination indicia comprising a preconceived pattern associated with information content of the destination wire, the destination indicia located on a portion of the surface.

9. A method of marking a telecommunications component, comprising the steps of:
establishing a destination indicia, wherein the destination indicia is associated with a destination wire of a telecommunications network, the destination wire having a first portion at least partially enclosed in a telecommunications closure and a second portion at least partially outside of the telecommunications closure, the second portion connected to a predetermined destination;
providing a surface for marking; and
marking a portion of the surface with the destination indicia.

10. The method of claim 9, further comprising the step of:
if the surface comprises a marking attachment, attaching the marking attachment to a predetermined portion of the telecommunications component.

11. The method of claim 9, wherein marking the portion of the surface with the destination indicia comprises the destination indicia having at least one alphanumeric character.

12. The method of claim 9, wherein marking the portion of the surface with the destination indicia comprises the destination indicia having at least one symbol.

13. The method of claim 9, wherein establishing the destination indicia comprises associating customer information to establish the destination indicia, the customer information comprising at least one of the following:
a customer's address;
a customer's telephone number;
a customer's telephone line;
a customer's account number; and
a customer's telecommunications provider.

14. The method of claim 9, wherein establishing the destination indicia comprises associating trackability information to establish the destination indicia, the network trackability information comprising data on at least one of the following:
at least one networked telecommunications component, the at least one networked telecommunications component being networked with the destination wire;
a manufacturing date;
a name of manufacturer;
a manufacturing model indicator;
a physical characteristic;
a repair history record;
a maintenance history record;
an installation record; and
a replacement parts record.

15. The method of claim 9, wherein marking the predetermined portion of the surface comprises differentiating planar colors of the destination indicia on the marked portion of the surface and of an unmarked portion of the surface.

16. The method of claim 9, wherein marking the portion of the surface comprises printing the destination indicia on the portion of the surface.

17. The method of claim 9, wherein marking the predetermined portion of the surface comprises etching the destination indicia on the portion of the surface.

18. The method of claim 9, wherein marking the predetermined portion of the surface comprises at least one of the following:
affixing a label on the portion of the surface.
applying a film on the portion of the surface;
applying a substrate on the portion of the surface; and
applying a magnetic substance on the portion of the surface.

19. The method of claim 9, further comprising the step of:
processing the telecommunications component in accordance with the destination indicia.

20. A method of marking a telecommunications component, comprising the steps of:
establishing a destination indicia, wherein the destination indicia is associated with a destination wire of a telecommunications network, the destination wire having a mated portion in a telecommunications closure and a routing portion outside of the telecommunications closure, the routing portion traveling to a predetermined destination;
providing the telecommunications component for marking;
preparing a portion of a surface for marking;
marking the portion of the surface with the destination indicia; and
if the surface comprises a marking attachment, attaching the marking attachment to the telecommunications component.

21. A method of interpreting a destination indicia located on a telecommunications component, comprising the steps of:
aligning a destination indicia located on a portion of a surface of a telecommunications component with a probe of an apparatus for reading the destination indicia, wherein the destination indicia is associated with at least one of customer data and trackability data;
reading the destination indicia with the probe; and
processing the destination indicia to interpret the at least one of customer data and trackability data.
